(19) United States
(12) Patent Application Publication
(10) Pub. No.: US 2025/0193699 A1
(43) Pub. Date: Jun. 12, 2025

(54) METHOD FOR TRAINING AND DEPLOYING MODEL AND COMMUNICATION DEVICE

(71) Applicant: BEIJING XIAOMI MOBILE SOFTWARE CO., LTD., Beijing (CN)

(72) Inventors: Liangang CHI, Beijing (CN); Wei XU, Beijing (CN)

(73) Assignee: BEIJING XIAOMI MOBILE SOFTWARE CO., LTD., Beijing (CN)

(21) Appl. No.: 18/846,116

(22) PCT Filed: Mar. 11, 2022
(86) PCT No.: PCT/CN2022/080478

§ 371 Date: Sep. 11, 2024

(51) Int. Cl. H04W 24/02; H04W 8/24

(52) U.S. Cl. CPC H04W 24/02; H04W 8/24

(57) ABSTRACT

The present disclosure provides a method for training and deploying a model. The method may is performed by a network device and include: obtaining capability information reported by a user equipment (UE), the capability information being configured to indicate at least one of an artificial intelligence (AI) supporting capability or a machine learning (ML) supporting capability of the UE; generating an encoder model and a decoder model based on the capability information; and sending model information of the encoder model to the UE for the UE to deploy the encoder model.

### CROSS-REFERENCE TO RELATED APPLICATIONS

The present application is a U.S. National Stage of International Application No. PCT/CN2022/080478 filed on Mar. 11, 2022, the entire content of which is incorporated herein by reference for all purposes.

### TECHNICAL FIELD

The present disclosure relates to the field of communication technology, and in particular, to a model training and deploying method/device/apparatus and storage medium.

### BACKGROUND

With the continuous development of AI (artificial intelligent) technology and ML (machine learning) technology, the application fields (e.g., image recognition, speech processing, natural language processing, gaming, etc.) of the AI technology and the ML technology are becoming more and more extensive. When using the AI technology and the ML technology, an AI/ML model is usually used to code and decode information.

### SUMMARY

The present disclosure proposes a model training and deploying method and a communication device.

An embodiment in one aspect of the present disclosure provides a method, which is applied to a network device, including:
obtaining capability information reported by a UE, the capability information being configured to indicate an AI supporting capability and/or an ML supporting capability of the UE;
generating an encoder model and a decoder model based on the capability information; and
sending model information of the encoder model to the UE, the model information of the encoder model being configured to deploy the encoder model.

An embodiment in another aspect of the present disclosure provides a method, which is applied to a UE, including:
reporting capability information to a network device, the capability information being configured to indicate an AI supporting capability and/or an ML supporting capability of the UE;
obtaining model information of an encoder model sent by the network device, the model information of the encoder model being configured to deploy the encoder model; and
generating the encoder model based on the model information of the encoder model.

An embodiment in yet another aspect of the present disclosure provides a device, including:
an obtaining module, configured to obtain capability information reported by a UE, the capability information being configured to indicate an AI supporting capability and/or an ML supporting capability of the UE;
a generating module, configured to generate an encoder model and a decoder model based on the capability information; and
a sending module, configured to send model information of the encoder model to the UE, the model information of the encoder model being configured to deploy the encoder model.

An embodiment in yet another aspect of the present disclosure provides a device, including:
a reporting module, configured to report capability information to a network device, the capability information being configured to indicate an AI supporting capability and/or an ML supporting capability of a UE;
an obtaining module, configured to obtain model information of an encoder model sent by the network device, the model information of the encoder model being configured to deploy the encoder model; and
a generating module, configured to generate the encoder model based on the model information of the encoder model.

An embodiment in yet another aspect of the present disclosure provides a communication device including a processor and a memory, the memory has a computer program stored therein, and the processor executes the computer program stored in the memory to cause the communication device to perform the method according to the embodiment in the above one aspect.

An embodiment in yet another aspect of the present disclosure provides a communication device including a processor and a memory, the memory has a computer program stored therein, and the processor executes the computer program stored in the memory to cause the communication device to perform the method according to the embodiment in the above another aspect.

An embodiment in yet another aspect of the present disclosure provides a communication device including a processor and an interface circuit, the interface circuitry is configured to receive code instructions and transmit the code instructions to the processor; and the processor is configured to run the code instructions to perform the method according to the embodiment in the above one aspect.

An embodiment in yet another aspect of the present disclosure provides a communication device including a processor and an interface circuit, the interface circuitry is configured to receive code instructions and transmit the code instructions to the processor; and the processor is configured to run the code instructions to perform the method according to the embodiment in the above another aspect.

An embodiment in yet another aspect of the present disclosure provides a computer-readable storage medium having instructions stored thereon that, when being executed, cause the method according to the embodiment in the above one aspect to be implemented.

An embodiment in yet another aspect of the present disclosure provides a computer-readable storage medium having instructions stored thereon that, when being executed, cause the method according to the embodiment in the above another aspect to be implemented.

### BRIEF DESCRIPTION OF THE DRAWINGS

The foregoing and/or additional aspects and advantages of the present disclosure will become apparent and readily understood from the following description of embodiments in conjunction with the accompanying drawings, in which:

FIG. 1 is a schematic flow diagram of a method according to an embodiment of the present disclosure.

FIG. 2a is a schematic flow diagram of a method according to another embodiment of the present disclosure.

FIG. 2b is a schematic flow diagram of a method according to yet another embodiment of the present disclosure.

FIG. 2c is a schematic flow diagram of a method according to yet another embodiment of the present disclosure.

FIG. 2d is a schematic flow diagram of a method according to yet another embodiment of the present disclosure.

FIG. 2e is a schematic flow diagram of a method according to yet another embodiment of the present disclosure.

FIG. 3a is a schematic flow diagram of a method according to yet another embodiment of the present disclosure.

FIG. 3b is a schematic flow diagram of a method according to yet another embodiment of the present disclosure.

FIG. 3c is a schematic flow diagram of a method according to yet another embodiment of the present disclosure.

FIG. 3d is a schematic flow diagram of a method according to yet another embodiment of the present disclosure.

FIG. 3e is a schematic flow diagram of a method according to yet another embodiment of the present disclosure.

FIG. 4 is a schematic flow diagram of a method according to yet another embodiment of the present disclosure.

FIG. 5 is a schematic flow diagram of a method according to yet another embodiment of the present disclosure.

FIG. 6a is a schematic flow diagram of a method according to yet another embodiment of the present disclosure.

FIG. 6b is a schematic flow diagram of a method according to yet another embodiment of the present disclosure.

FIG. 6c is a schematic flow diagram of a method according to yet another embodiment of the present disclosure.

FIG. 6d is a schematic flow diagram of a method according to yet another embodiment of the present disclosure.

FIG. 7 is a schematic structure diagram of a device according to an embodiment of the present disclosure.

FIG. 8 is a schematic structure diagram of a device according to another embodiment of the present disclosure.

FIG. 9 is a block diagram of a user equipment according to an embodiment of the present disclosure.

FIG. 10 is a block diagram of a network side device according to an embodiment of the present disclosure.

### DETAILED DESCRIPTION

Embodiments will be described herein in detail, examples of which are represented in the accompanying drawings. When the following description relates to the accompanying drawings, the same reference numeral in different figures indicates the same or similar elements unless otherwise indicated. The implementations described in the following embodiments do not represent all the implementations consistent with embodiments of the present disclosure. Rather, they are only examples of devices and methods consistent with some aspects of embodiments of the present disclosure as detailed in the appended claims.

The term used in embodiments of the present disclosure is used solely for describing particular embodiments and is not intended to limit embodiments of the present disclosure. The singular forms of “a”, “an” and “the” used in embodiments of the present disclosure and the appended claims are also intended to encompass the plural forms unless otherwise indicated. It should also be understood that the term “and/or” as used herein refers to and include any or all possible combinations of one or more associated listed items.

It should be understood that while the terms “first”, “second”, “third”, etc. may be used in embodiments of the present disclosure to describe various information, such information should not be limited by these terms. These terms are only used to distinguish the same type of information from one another. For example, without departing from the scope of embodiments of the present disclosure, first information may also be referred to as second information, and similarly, the second information may be referred to as the first information. Depending on the context, the word “if” as used herein may be interpreted as “at” or “when” or “in response to determining”.

A model training and deploying method/device/apparatus and storage medium according to embodiments of the present disclosure are described in detail below with reference to the accompanying drawings.

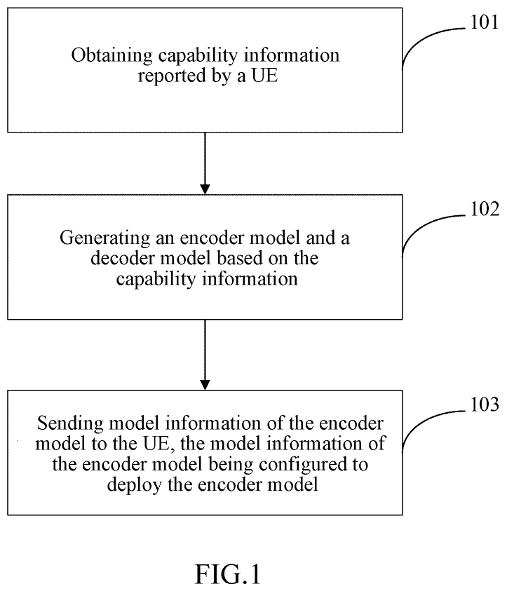

FIG. 1 is a schematic flow diagram of a method of training and deploying a model according to an embodiment of the present disclosure, which is executed by a network device. As shown in FIG. 1, the method may include the following steps.

In step 101, capability information reported by a UE (user equipment) is obtained.

It is to be noted that in an embodiment of the present disclosure, the UE may be a device that provides voice and/or data connectivity to a user. A terminal device may communicate with one or more core networks via a RAN (Radio Access Network), and the UE may be an IoT terminal such as a sensor device, a mobile phone (or “cellular” phone), and a computer with an IoT terminal, for example, it may be fixed, portable, pocket-sized, handheld, computer-integrated, or in-vehicle device, such as a station (STA), a subscriber unit, a subscriber station, a mobile station, a mobile, a remote station, an access point, a remote terminal, an access terminal, a user terminal, or a user agent. In an embodiment, the UE may be a device of an unmanned aerial vehicle. In an embodiment, the UE may be an in-vehicle device, e.g., a trip computer with a wireless communication capability, or a wireless terminal externally connected to a trip computer. Alternatively, the UE may be a roadside device, e.g., a street light, a signal light, or other roadside device having a wireless communication capability.

In an embodiment of the present disclosure, the capability information may be configured to indicate an artificial intelligence (AI) supporting capability and/or a machine learning (ML) supporting capability of the UE.

In an embodiment of the present disclosure, the model may include at least one of:
an AI model; or
an ML model.

In an embodiment of the present disclosure, the above capability information may include at least one of:
whether the UE supports AI;
whether the UE supports ML;
a kind of an AI model and/or an ML model supported by the UE; and
maximum supporting capability information of the UE for the model, the maximum supporting capability information including structure information of a most-complex model supported by the UE.

In an embodiment of the present disclosure, the above structure information may include, for example, a number of layers of the model, or the like.

In step 102, an encoder model and a decoder model are generated based on the capability information.

In an embodiment of the present disclosure, a plurality of different encoder models to be trained and/or a plurality of different decoder models to be trained are stored in the network device. There is a correspondence between the encoder model and the decoder model. After obtaining the capability information sent by the UE, the network device may select, based on the capability information, a to-be-trained encoder model matching the AI supporting capability and/or the ML supporting capability of the UE, and/or select a to-be-trained decoder model matching the AI supporting capability and/or the ML supporting capability of the network device itself, and then generate the encoder model and/or to-be-trained decoder model by training the to-be-trained encoder model and/or the to-be-trained decoder model.

A detailed and specific method for generating the encoder model and the decoder model based on the capability information as described above will be described in subsequent embodiments.

In step 103, model information of the encoder model is sent to the UE, the model information of the encoder model may be configured to deploy the encoder model.

In an embodiment of the present disclosure, the above model information of the encoder model may include at least one of:
a kind of the encoder model; or
a model parameter of the encoder model.

In an embodiment of the present disclosure, the kind of the above encoder model may include:
a CNN (convolutional neural network) model;
a fully-connected DNN (deep neural network) model; or
a combined model of a CNN and a fully-connected DNN.

It is to be noted that in an embodiment of the present disclosure, when the kinds of encoder models are different, the model parameters of the encoder models may also be different.

Specifically, in an embodiment of the present disclosure, when the encoder model is a CNN model, the model parameter of the encoder model may include at least one of a compression rate of the CNN model, a number of convolutional layers of the CNN model, arrangement information between respective convolutional layers, weight information of each convolutional layer, a size of the convolution kernel of each convolutional layer, a type of an activation function or a type of a normalization layer applied to each convolutional layer.

In another embodiment of the present disclosure, when the encoder model is a fully-connected DNN model, the model parameter of the encoder model may include at least one of a compression rate of the fully-connected DNN model, a number of fully-connected layers, arrangement information between respective fully-connected layers, weight information of each fully-connected layer, a number of nodes of each fully-connected layers, a type of an activation function or a type of a normalization layer applied to each fully-connected layer.

In yet another embodiment of the present disclosure, when the encoder model is a combined model of CNN and fully-connected DNN, the model parameter of the encoder model may include a compression rate of the combined model of CNN and fully-connected DNN, numbers of convolutional layers and fully-connected layers, a collocation pattern, weight information of the convolutional layer, a size of a convolution kernel, a number of nodes of the fully-connected layer, weight information of the fully-connected layer, a type of an activation function or a type of a normalization layer applied to each fully-connected layer and each convolutional layer.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

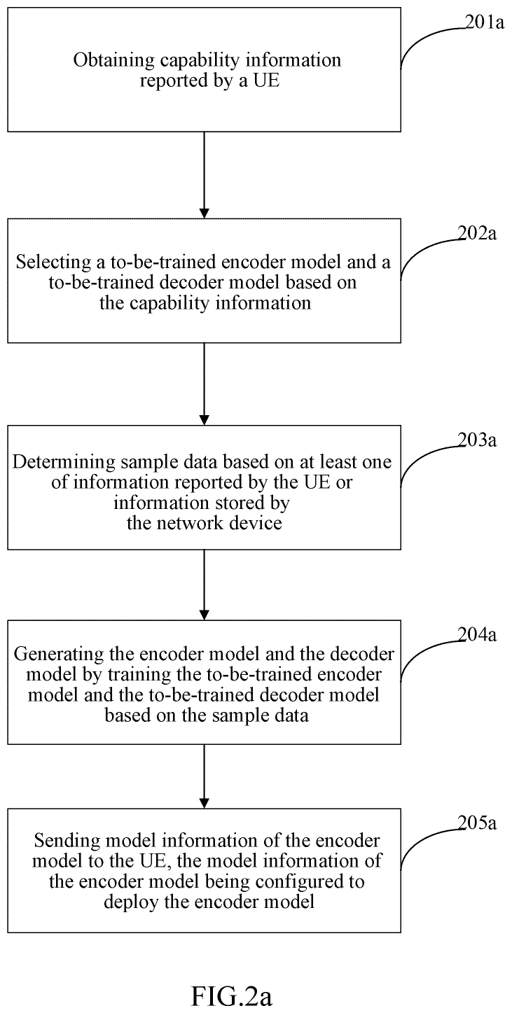

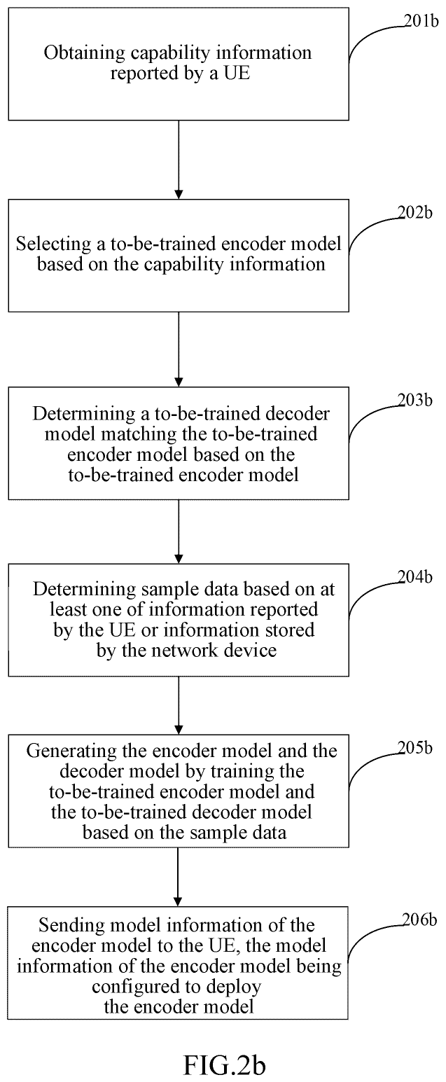

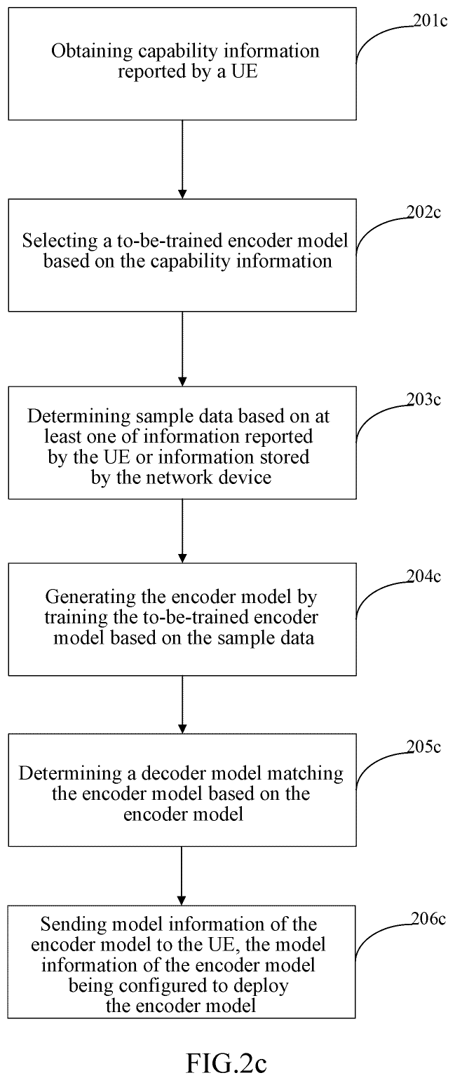

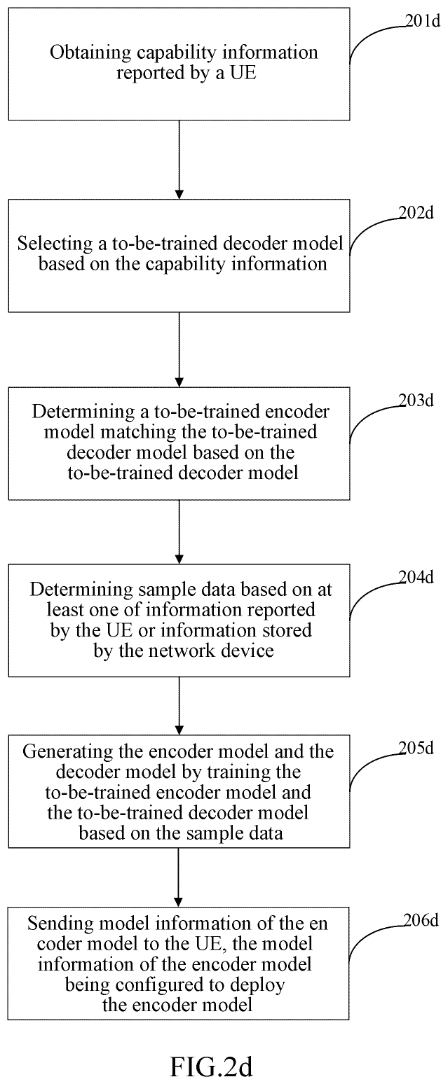

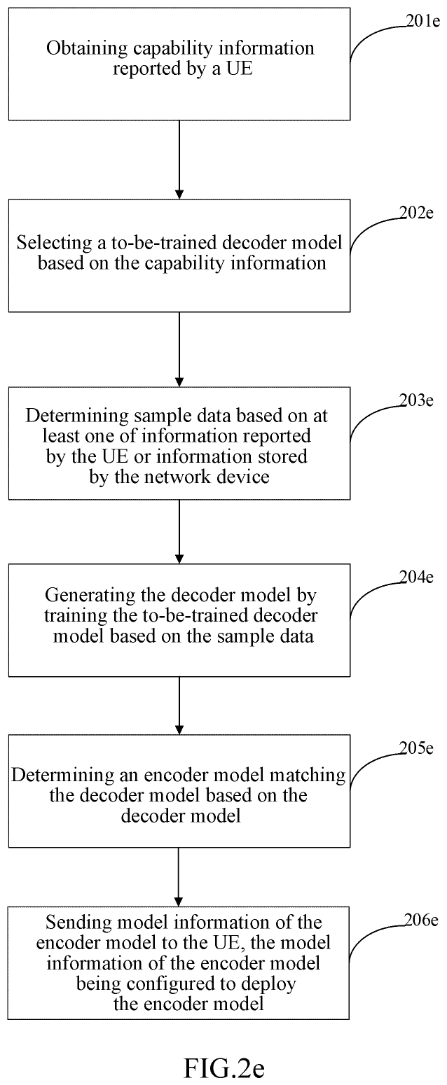

FIG. 2a is a schematic flow diagram of a method for training and deploying a model according to an embodiment of the present disclosure, which is executed by a network device. As shown in FIG. 2a, the method may include the following steps.

In step 201a, capability information reported by a UE is obtained.

Details of step 201a may refer to the description of the above embodiments, which are not repeated herein in the embodiment of the present disclosure.

In step 202a, a to-be-trained encoder model and a to-be-trained decoder model are selected based on the capability information.

In an embodiment of the present disclosure, the network device may select a to-be-trained encoder model supported by the UE and a to-be-trained decoder model supported by the network device based on the capability information from a plurality of different to-be-trained encoder models and a plurality of different to-be-trained decoder models stored in the network device. The to-be-trained encoder model and the to-be-trained decoder model selected by the network device correspond to each other.

In step 203a, sample data is determined based on at least one of information reported by the UE and information stored by the network device.

In an embodiment of the present disclosure, the above information reported by the UE may be information currently reported by the UE or information historically reported by the UE.

In an embodiment of the present disclosure, the above information may be information reported by the UE which has not been encoded and compressed, and/or information reported by the UE which has been encoded and compressed.

In step 204a, the encoder model and the decoder model are generated by training the to-be-trained encoder model and the to-be-trained decoder model based on the sample data.

In step 205a, model information of the encoder model is sent to the UE, the model information of the encoder model being configured to deploy the encoder model.

Details of step 205a may refer to the description of the above embodiments, which are not repeated herein in the embodiment of the present disclosure.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 2b is a schematic flow diagram of a method for training and deploying a model according to an embodiment of the present disclosure, which is executed by a network device. As shown in FIG. 2b, the method may include the following steps.

In step 201b, capability information reported by a UE is obtained.

Details of step 201b may refer to the description of the above embodiments, which are not repeated herein in the embodiment of the present disclosure.

In step 202b, a to-be-trained encoder model is selected based on the capability information.

In an embodiment of the present disclosure, the network device may select a to-be-trained encoder model supported by the UE based on the capability information from a plurality of different to-be-trained encoder models stored in the network device.

In addition, it is to be noted that in an embodiment of the present disclosure, the above to-be-trained encoder model may satisfy the following conditions:
1. the selected to-be-trained encoder model may be a model that matches the capability information of the UE (i.e., a model supported by the UE); and
2. the to-be-trained decoder model corresponding to the selected to-be-trained encoder model may be a model supported by the network device.

In step 203b, a to-be-trained decoder model matching the to-be-trained encoder model is determined based on the to-be-trained encoder model.

Specifically, in an embodiment of the present disclosure, the model information of the to-be-trained decoder model matching the to-be-trained encoder model may be determined based on the model information of the to-be-trained encoder model, and then the to-be-trained decoder model is deployed based on the model information of the to-be-trained decoder model.

In step 204b, sample data is determined based on at least one of information reported by the UE or information stored by the network device.

In an embodiment of the present disclosure, the above information reported by the UE may be information currently reported by the UE or information historically reported by the UE.

In an embodiment of the present disclosure, the above information may be information reported by the UE which has not been encoded and compressed, and/or information reported by the UE which has been encoded and compressed.

In step 205b, the encoder model and the decoder model are generated by training the to-be-trained encoder model and the to-be-trained decoder model based on the sample data.

In step 206b, model information of the encoder model is sent to the UE, the model information of the encoder model being configured to deploy the encoder model.

Details of step 206b may refer to the description of the above embodiments, which are not repeated herein in the embodiment of the present disclosure.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 2c is a schematic flow diagram of a method for training and deploying a model according to an embodiment of the present disclosure, which is executed by a network device. As shown in FIG. 2c, the method may include the following steps.

In step 201c, capability information reported by a UE is obtained.

Details of step 201c may refer to the description of the above embodiments, which are not repeated herein in the embodiment of the present disclosure.

In step 202c, a to-be-trained encoder model is selected based on the capability information.

In an embodiment of the present disclosure, the network device may select a to-be-trained encoder model supported by the UE based on the capability information from a plurality of different to-be-trained encoder models stored in the network device.

In addition, it is to be noted that in an embodiment of the present disclosure, the above to-be-trained encoder model may satisfy the following conditions:
1. the selected to-be-trained encoder model may be a model that matches the capability information of the UE (i.e., a model supported by the UE); and
2. the to-be-trained decoder model corresponding to the selected to-be-trained encoder model may be a model supported by the network device.

In step 203c, sample data is determined based on at least one of information reported by the UE or information stored by the network device.

In an embodiment of the present disclosure, the above information reported by the UE may be information currently reported by the UE or information historically reported by the UE.

In an embodiment of the present disclosure, the above information may be information reported by the UE which has not been encoded and compressed, and/or information reported by the UE which has been encoded and compressed.

In step 204c, the encoder model is generated by training the to-be-trained encoder model based on the sample data.

In step 205c, a decoder model matching the encoder model is determined based on the encoder model.

Specifically, in an embodiment of the present disclosure, the model information of the decoder model matching the encoder model may be determined based on the model information of the encoder model, and then the decoder model is deployed based on the model information of the decoder model.

In step 206c, model information of the encoder model is sent to the UE, the model information of the encoder model being configured to deploy the encoder model.

Details of step 206c may refer to the description of the above embodiments, which are not repeated herein in the embodiment of the present disclosure.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 2d is a schematic flow diagram of a method for training and deploying a model according to an embodiment of the present disclosure, which is executed by a network device. As shown in FIG. 2d, the method may include the following steps.

In step 201d, capability information reported by a UE is obtained. Details of step 201d may refer to the description of the above embodiments, which are not repeated herein in the embodiment of the present disclosure.

In step 202d, a to-be-trained decoder model is selected based on the capability information.

In an embodiment of the present disclosure, the network device may select a to-be-trained decoder model based on the capability information from a plurality of different to-be-trained decoder models stored in the network device.

It is to be noted that in an embodiment of the present disclosure, the above description of “selecting the to-be-trained decoder model based on the capability information” specifically means that: when selecting the to-be-trained decoder model based on the capability information, the selected to-be-trained decoder model may satisfy the following conditions:
1. the selected to-be-trained decoder model may be a model supported by the network; and
2. the to-be-trained encoder model corresponding to the selected to-be-trained decoder model may be a model matching the capability information of the UE (i.e., a model supported by the UE).

In step 203d, a to-be-trained encoder model matching the to-be-trained decoder model is determined based on the to-be-trained decoder model.

Specifically, in an embodiment of the present disclosure, model information of the to-be-trained encoder model matching the to-be-trained decoder model may be determined based on the model information of the to-be-trained decoder model, and then the to-be-trained encoder model is deployed based on the model information of the to-be-trained encoder model.

In step 204d, sample data is determined based on at least one of information reported by the UE or information stored by the network device.

In an embodiment of the present disclosure, the above information reported by the UE may be information currently reported by the UE or information historically reported by the UE.

In an embodiment of the present disclosure, the above information may be information reported by the UE which has not been encoded and compressed, and/or information reported by the UE which has been encoded and compressed. In step 205d, the encoder model and the decoder model are generated by training the to-be-trained encoder model and the to-be-trained decoder model based on the sample data.

In step 206d, model information of the encoder model is sent to the UE, the model information of the encoder model being configured to deploy the encoder model.

Details of step 206d may refer to the description of the above embodiments, which are not repeated herein in the embodiment of the present disclosure.

FIG. 2e is a schematic flow diagram of a method for training and deploying a model according to an embodiment of the present disclosure, which is executed by a network device. As shown in FIG. 2e, the method may include the following steps. In step 201e, capability information reported by a UE is obtained.

Details of step 201e may refer to the description of the above embodiments, which are not repeated herein in the embodiment of the present disclosure.

In step 202e, a to-be-trained decoder model is selected based on the capability information.

In an embodiment of the present disclosure, the network device may select a to-be-trained decoder model based on the capability information from a plurality of different to-be-trained decoder models stored in the network device.

It is to be noted that in an embodiment of the present disclosure, the above description of “selecting the to-be-trained decoder model based on the capability information” specifically means that: when selecting the to-be-trained decoder model based on the capability information, the selected to-be-trained decoder model may satisfy the following conditions:
1. the selected to-be-trained decoder model may be a model supported by the network; and
2. the to-be-trained encoder model corresponding to the selected to-be-trained decoder model may be a model matching the capability information of the UE (i.e., a model supported by the UE).

In step 203e, sample data is determined based on at least one of information reported by the UE or information stored by the network device.

In an embodiment of the present disclosure, the above information reported by the UE may be information currently reported by the UE or information historically reported by the UE.

In an embodiment of the present disclosure, the above information may be information reported by the UE which has not been encoded and compressed, and/or information reported by the UE which has been encoded and compressed.

In step 204e, the decoder model is generated by training the to-be-trained decoder model based on the sample data.

In step 205e, an encoder model matching the decoder model is determined based on the decoder model.

Specifically, in an embodiment of the present disclosure, model information of the encoder model matching the decoder model may be determined based on the model information of the decoder model, and then the encoder model is deployed based on the model information of the encoder model.

In step 206e, model information of the encoder model is sent to the UE, the model information of the encoder model being configured to deploy the encoder model.

Details of step 206e may refer to the description of the above embodiments, which are not repeated herein in the embodiment of the present disclosure.

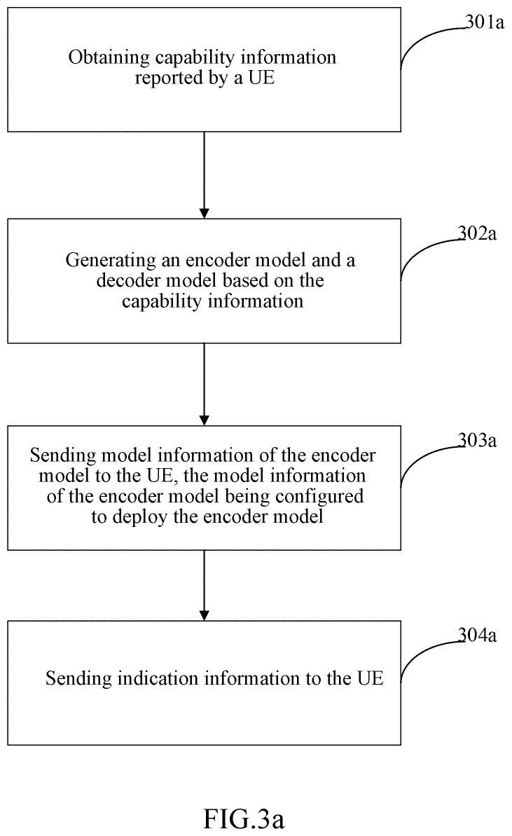

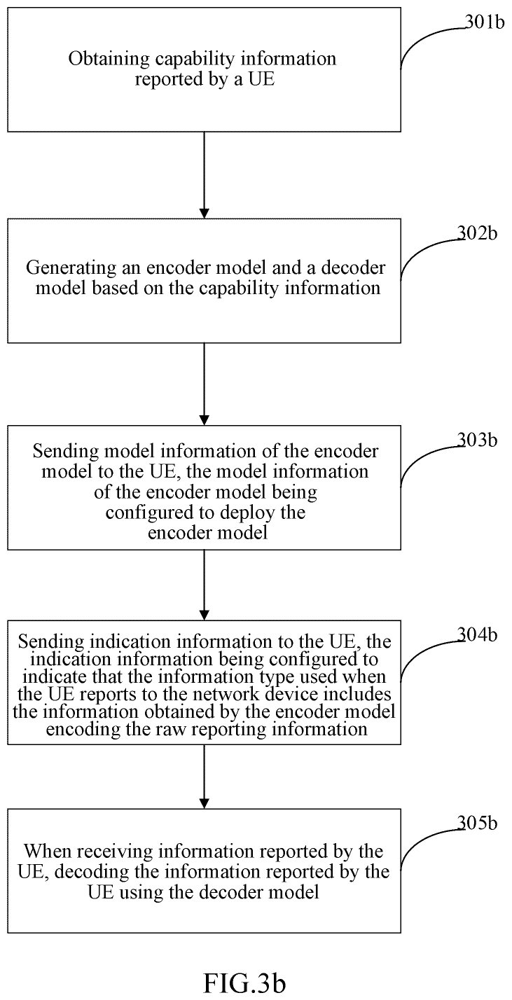

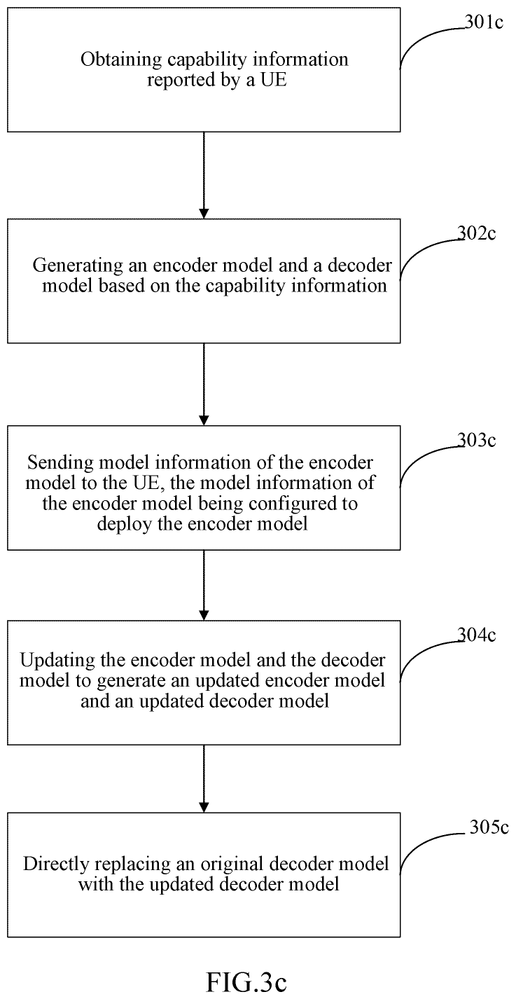

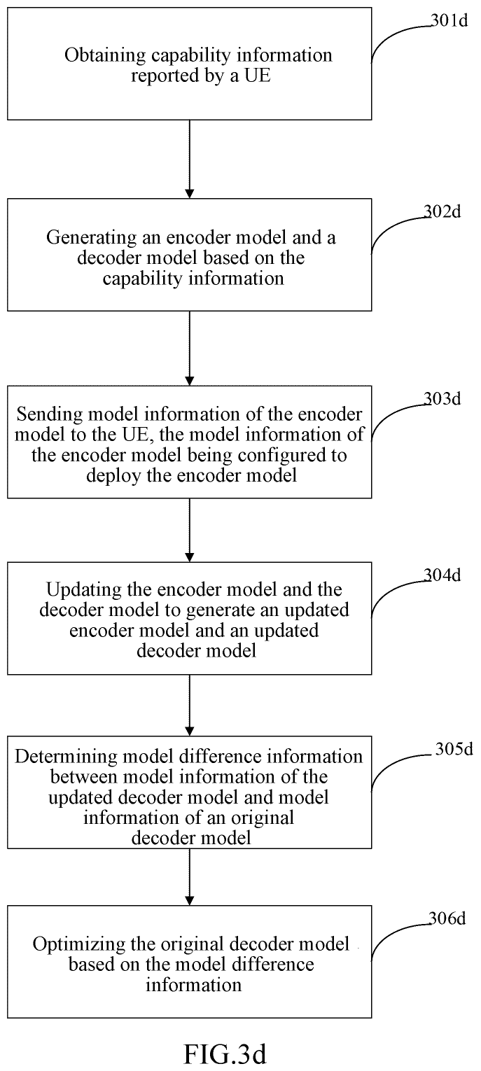

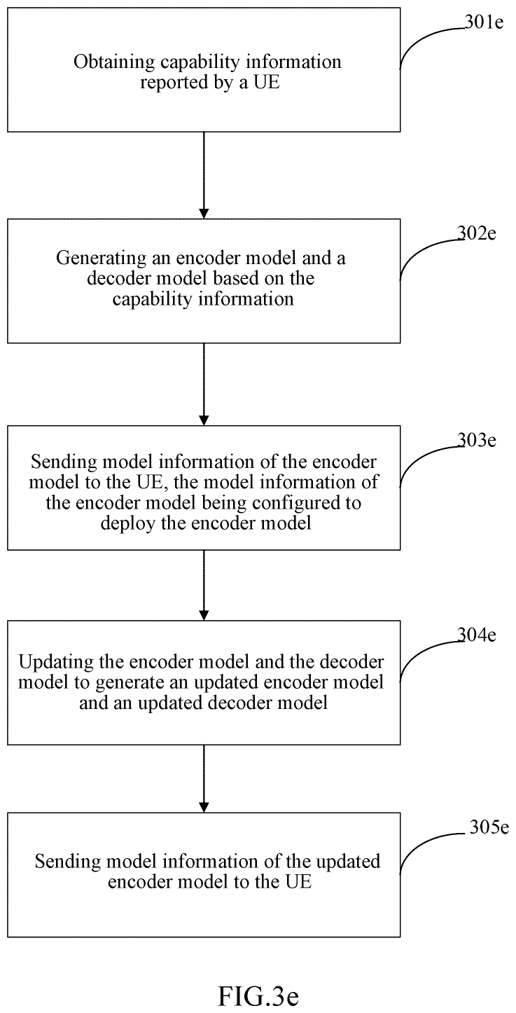

FIG. 3a is a schematic flow diagram of a method of training and deploying a model according to an embodiment of the present disclosure, which is executed by a network device. As shown in FIG. 3a, the method may include the following steps.

In step 301a, capability information reported by a UE is obtained.

In step 302a, an encoder model and a decoder model are generated based on the capability information.

In step 303a, model information of the encoder model is sent to the UE, the model information of the encoder model being configured to deploy the encoder model.

Other details of steps 301a to 303a may refer to the description of the above embodiments, which are not repeated herein in the embodiment of the present disclosure. In step 304a, indication information is sent to the UE.

In an embodiment of the present disclosure, the indication information may be configured to indicate an information type used when the UE reports to the network device.

In an embodiment of the present disclosure, the information type may include at least one of:
information obtained by the encoder model encoding the raw reporting information.

Further, in an embodiment of the present disclosure, the reporting information may be information to be reported by the UE to the network device. The reporting information may include CSI (channel state information) information.

raw reporting information not encoded by the encoder model; or

In an embodiment of the present disclosure, the CSI information may include at least one of:
channel information;
characteristic matrix information of a channel;
eigenvector information of the channel;
PMI (precoding matrix indication indicator);
CQI (channel quality indicator);
RI (channel rank indicator);
RSRP (reference signal received power);
RSRQ (reference signal received quality);

1SINR (signal-to-interference plus noise ratio); or
reference signal resource indication.

In addition, in an embodiment of the present disclosure, the network device may send the indication information to the UE via signaling.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 3b is a schematic flow diagram of a method of training and deploying a model according to an embodiment of the present disclosure, which is executed by a network device. As shown in FIG. 3b, the method may include the following steps.

In step 301b, capability information reported by a UE is obtained.

In step 302b, an encoder model and a decoder model are generated based on the capability information.

In step 303b, model information of the encoder model is sent to the UE, the model information of the encoder model being configured to deploy the encoder model.

In step 304b, indication information is sent to the UE. The indication information is configured to indicate that the information type used when the UE reports to the network device includes the information obtained by the encoder model encoding the raw reporting information.

Other details of steps 303b to 304b may refer to the description of the above embodiments, which are not repeated herein in the embodiment of the present disclosure.

In step 305b, when receiving information reported by the UE, the information reported by the UE is decoded using the decoder model.

In an embodiment of the present disclosure, the above step 304b indicates that the information type used when the UE reports is information obtained after the encoding of the encoder model, therefore the information reported by the UE received by the network device in step 305b is essentially information encoded by the encoder model, based on which the network device may use a decoder model (e.g., the decoder model generated in the above step 303b) to decode the information reported by the UE to obtain the original reporting information.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 3c is a schematic flow diagram of a method of training and deploying a model according to an embodiment of the present disclosure, which is executed by a network device. As shown in FIG. 3c, the method may include the following steps.

In step 301c, capability information reported by a UE is obtained.

In step 302c, an encoder model and a decoder model are generated based on the capability information.

In step 303c, model information of the encoder model is sent to the UE, the model information of the encoder model being configured to deploy the encoder model.

Other details of steps 301c to 303c may refer to the description of the above embodiments, which are not repeated herein in the embodiment of the present disclosure.

In step 304c, the encoder model and the decoder model are updated to generate an updated encoder model and an updated decoder model.

In an embodiment of the present disclosure, updating the encoder model and the decoder model may specifically include the following steps 1 and 2.

In step 1, a new encoder model and a new decoder model are determined based on an original encoder model and an original decoder model.

In an embodiment of the present disclosure, the new encoder model and the new decoder model may be determined when the network device adjusts the compression rate of the encoder model and the decoder model.

In an embodiment of the present disclosure, the above method of determining the new encoder model and the new decoder model may include:
obtaining the new encoder model and the new decoder model by adjusting a model parameter of the original encoder model and the original decoder model; or
re-selecting the new encoder model and the new decoder model based on the capability information, a kind of the new encoder model and the new decoder model being different from a kind of the original encoder model and the original decoder model, the new encoder model being a model supported by the UE, and the new decoder model being a model supported by the network device.

In step 2, the updated encoder model and the updated decoder model are obtained by retraining the new encoder model and the new decoder model.

The retraining process may specifically refer to the description of the above embodiments, which is not repeated herein in the embodiment of the present disclosure.

Further, in another embodiment of the present disclosure, updating the encoder model and the decoder model may specifically include the following steps a and b.

In step a, a distortion degree of an original encoder model and an original decoder model is monitored.

In an embodiment of the present disclosure, the distortion degree of the original encoder model and the original decoder model may be monitored in real time. Specifically, the information reported by the UE which has not been encoded and compressed may be sequentially input into the original encoder model and the original decoder model as input information to be sequentially encoded and decoded to obtain output information, and the distortion degree of the original encoder model and the original decoder model may be determined by calculating a matching degree between the output information and the input information.

In step b, when the distortion degree exceeds a first threshold, a new encoder model and a new decoder model are determined based on the original encoder model and the original decoder model, and the updated encoder model and the updated decoder model are obtained by retraining the new encoder model and the new decoder model, wherein a distortion degree of the updated encoder model and the updated decoder model is less than a second threshold, and the second threshold is less than or equal to the first threshold.

In an embodiment of the present disclosure, when the distortion degree exceeds the first threshold, it indicates that the original encoder model and the original decoder model have a low encoding and decoding accuracy, which may affect the subsequent processing accuracy of a signal. As a result, a new encoder model and a new decoder model may be determined, and the new encoder model and the new decoder model may be retrained to obtain the updated encoder model and the updated decoder model. It may ensure that the updated encoder model and the updated decoder model have a low distortion degree below the second threshold so as to ensure the encoding and decoding accuracy of the model.

The method of determining the new encoder model and the new decoder model and the method of retraining the same as described above may be specifically referred to the description of the above embodiments, which are not repeated herein in the embodiment of the present disclosure.

Furthermore, in an embodiment of the present disclosure, the above first threshold and second threshold may be pre-set.

In step 305c, an original decoder model is directly replaced with the updated decoder model.

In an embodiment of the present disclosure, after the original decoder model is replaced by the updated decoder model, the network device may use the updated decoder model for decoding. Based on the higher decoding accuracy of the updated decoder model, the subsequent processing accuracy of the signal may be ensured.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 3d is a schematic flow diagram of a method of training and deploying a model according to an embodiment of the present disclosure, which is executed by a network device. As shown in FIG. 3d, the method may include the following steps.

In step 301d, capability information reported by a UE is obtained.

In step 302d, an encoder model and a decoder model are generated based on the capability information.

In step 303d, model information of the encoder model is sent to the UE, the model information of the encoder model being configured to deploy the encoder model.

In step 304d, the encoder model and the decoder model are updated to generate an updated encoder model and an updated decoder model.

Other details of steps 301d to 304d may refer to the description of the above embodiments, which are not repeated herein in the embodiment of the present disclosure.

In step 305d, model difference information between model information of the updated decoder model and model information of an original decoder model is determined.

A relevant description of the model information may be referred to the description of the above embodiments, which is not repeated herein the embodiment of the present disclosure.

In step 306d, the original decoder model is optimized based on the model difference information.

Specifically, in an embodiment of the present disclosure, after the original decoder model is optimized and adjusted based on the model difference information, the model information of the optimized and adjusted decoder model may be consistent with the model information of the updated decoder model generated in the above step 304d, so that the network device may subsequently perform a decoding operation using the updated decoder model. Based on the high decoding accuracy of the updated decoder model, the subsequent processing accuracy of the signal may be ensured.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 3e is a schematic flow diagram of a method of training and deploying a model according to an embodiment of the present disclosure, which is executed by a network device. As shown in FIG. 3e, the method may include the following steps.

In step 301e, capability information reported by a UE is obtained. In step 302e, an encoder model and a decoder model are generated based on the capability information.

In step 303e, model information of the encoder model is sent to the UE, the model information of the encoder model being configured to deploy the encoder model.

In step 304e, the encoder model and the decoder model are updated to generate an updated encoder model and an updated decoder model.

Other details of steps 301e to 303e may refer to the description of the above embodiments, which are not repeated herein in the embodiment of the present disclosure.

In step 305e, model information of the updated encoder model is sent to the UE.

In an embodiment of the present disclosure, the model information of the updated encoder model may include:
all model information of the updated encoder model; or
model difference information between the model information of the updated encoder model and model information of the original encoder model.

In an embodiment of the present disclosure, the network device sends the model information of the updated encoder model to the UE, so that the UE may use the updated encoder model for encoding. Based on the higher encoding accuracy of the updated encoder model, the subsequent processing accuracy of the signal may be ensured.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

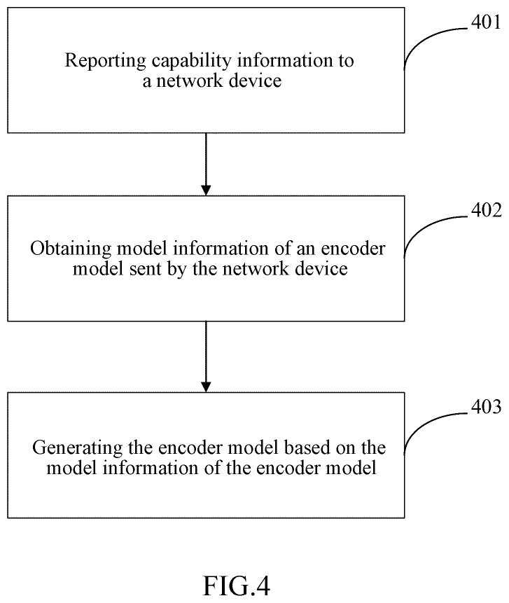

FIG. 4 is a schematic flow diagram of a method of training and deploying a model according to an embodiment of the present disclosure, which is executed by a UE. As shown in FIG. 4, the method may include the following steps.

In step 401, capability information is reported to a network device.

In an embodiment of the present disclosure, the capability information is configured to indicate an AI supporting capability and/or an ML supporting capability of the UE.

In an embodiment of the present disclosure, the model may include at least one of:
an AI model; or
an ML model.

Further, in an embodiment of the present disclosure, the capability information may include at least one of:
whether the UE supports AI;
whether the UE supports ML;
a kind of an AI model and/or an ML model supported by the UE; or
maximum supporting capability information of the UE for the model, the maximum supporting capability information including structure information of a most-complex model supported by the UE.

In an embodiment of the present disclosure, the above structure information may include, for example, a number of layers of the model, or the like.

In step 402, model information of an encoder model sent by the network device is obtained.

In an embodiment of the present disclosure, the model information of the encoder model is configured to deploy the encoder model.

In an embodiment of the present disclosure, the model information of the encoder model may include at least one of:
a kind of the encoder model; or a model parameter of the encoder model.

In step 403, the encoder model is generated based on the model information of the encoder model.

Other details of steps 401 to 403 may be referred to the description of the above embodiments, which are not repeated herein in the embodiment of the present disclosure. In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

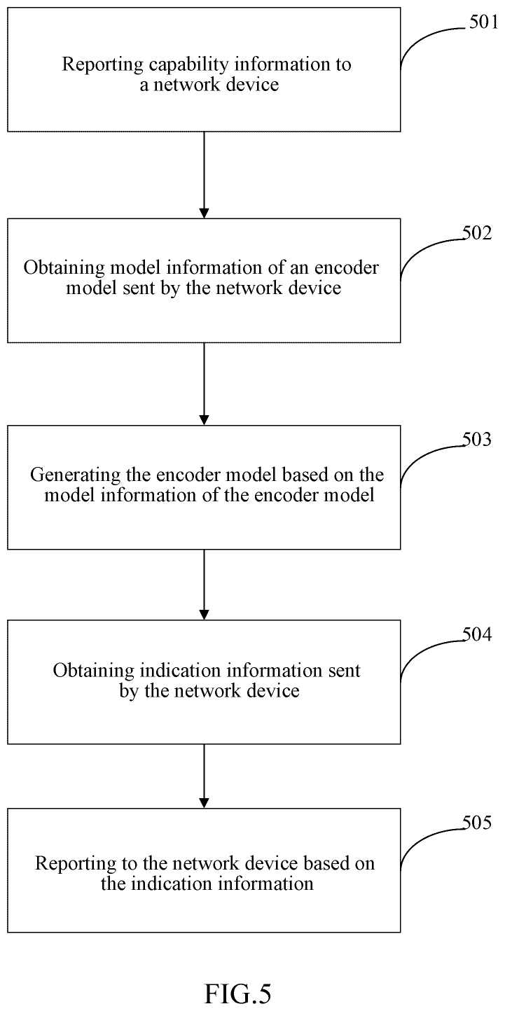

FIG. 5 is a schematic flow diagram of a method of training and deploying a model according to an embodiment of the present disclosure, which is executed by a UE. As shown in FIG. 5, the method may include the following steps.

In step 501, capability information is reported to a network device.

In step 502, model information of an encoder model sent by the network device is obtained.

In step 503, the encoder model is generated based on the model information of the encoder model.

Other details of steps 501 to 503 may be referred to the description of the above embodiments, which are not repeated herein in the embodiment of the present disclosure.

In step 504, indication information sent by the network device is obtained.

In an embodiment of the present disclosure, the indication information is configured to indicate an information type used when the UE reports to the network device.

In an embodiment of the present disclosure, the information type may include at least one of raw reporting information not encoded by the encoder model or information obtained by the encoder model encoding the raw reporting information.

Further, in an embodiment of the present disclosure, the reporting information is information to be reported by the UE to the network device. The reporting information may include CSI information.

The CSI information may include at least one of:
channel information;
characteristic matrix information of a channel;
eigenvector information of the channel;
PMI;
CQI;
RI;
RSRP;
RSRQ;
SINR; or
reference signal resource indication.

In step 505, it reports to the network device based on the indication information.

In an embodiment of the present disclosure, when the indication information in the above step 504 is configured to indicate that the information type used when the UE reports to the network device is the raw reporting information not encoded by the encoder model, the UE may directly send the raw reporting information to the network device without encoding the same during reporting to the network device in the step 505. Further, when the indication information in the above step 504 is configured to indicate that the information type used when the UE reports to the network device is the information obtained by the encoder model encoding the raw reporting information, the UE may encode the reporting information and report the encoded information to the network device during reporting to the network device in the step 505.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

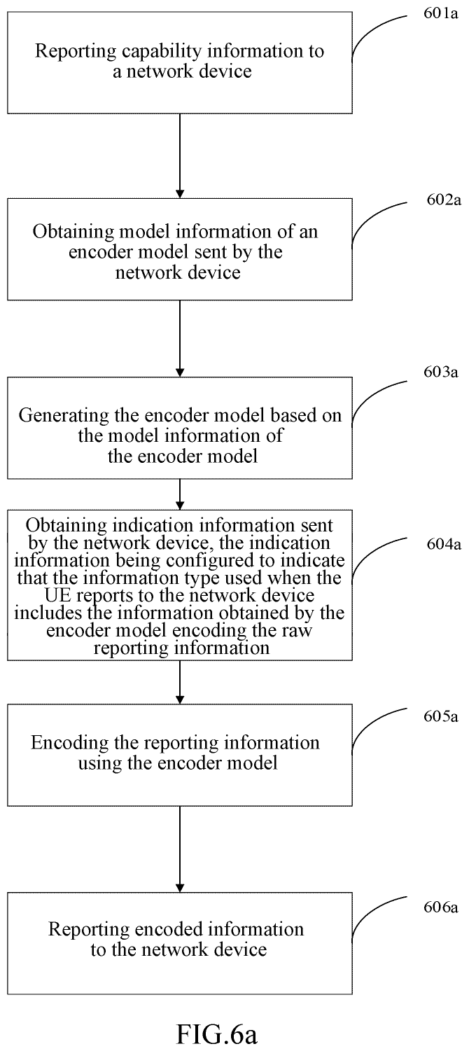

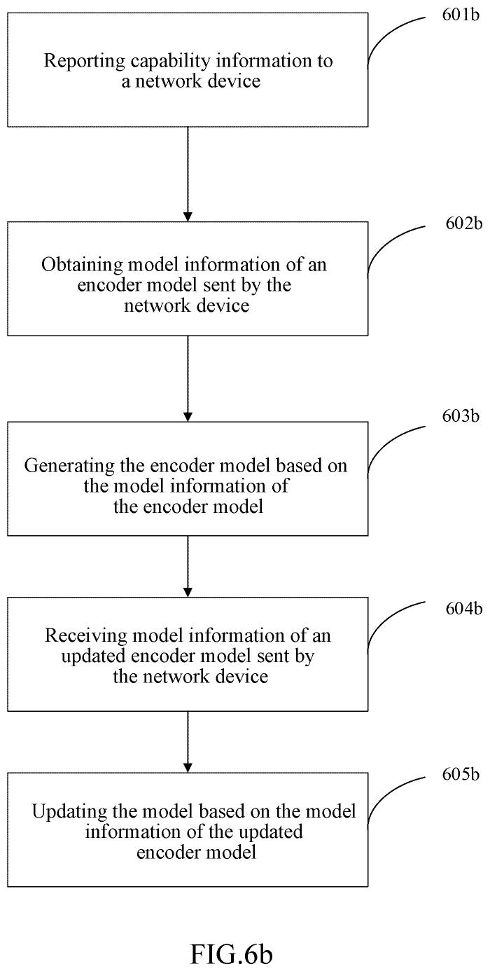

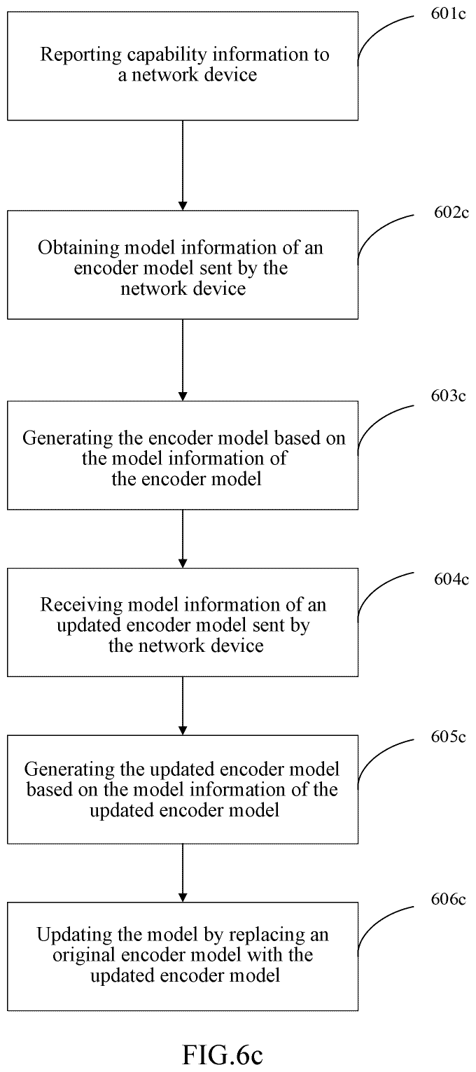

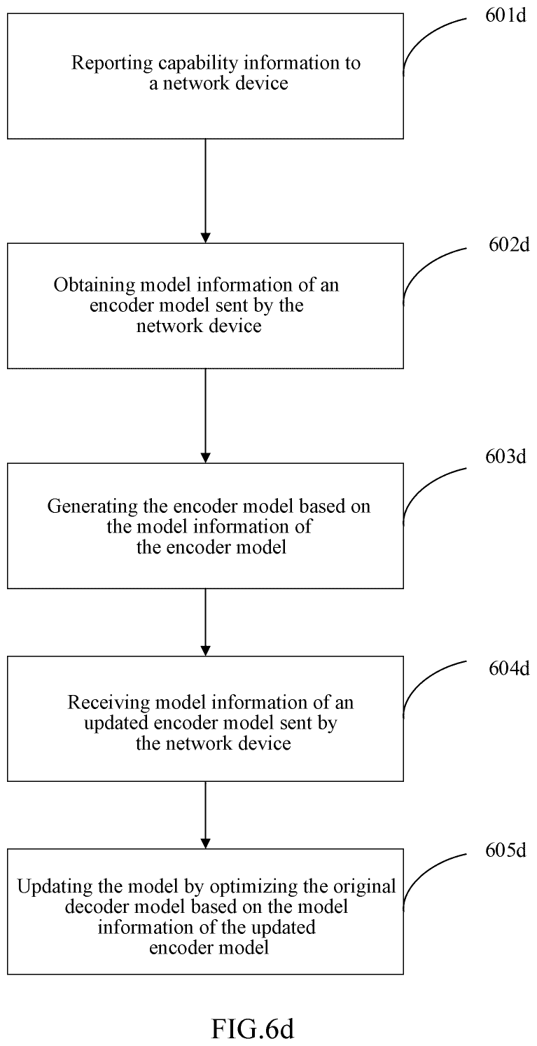

FIG. 6a is a schematic flow diagram of a method of training and deploying a model according to an embodiment of the present disclosure, which is executed by a UE. As shown in FIG. 6a, the method may include the following steps.

In step 601a, capability information is reported to a network device.

In step 602a, model information of an encoder model sent by the network device is obtained.

In step 603a, the encoder model is generated based on the model information of the encoder model.

Other details of steps 601a to 603a may be referred to the description of the above embodiments, which are not repeated herein in the embodiment of the present disclosure.

In step 604a, indication information sent by the network device is obtained. The information type indicated by the indication information may include the information obtained by the encoder model encoding the raw reporting information.

In step 605a, the reporting information is encoded using the encoder model.

In step 606a, encoded information is reported to the network device.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 6b is a schematic flow diagram of a method of training and deploying a model according to an embodiment of the present disclosure, which is executed by a UE. As shown in FIG. 6b, the method may include the following steps.

In step 601b, capability information is reported to a network device.

In step 602b, model information of an encoder model sent by the network device is obtained.

In step 603b, the encoder model is generated based on the model information of the encoder model.

Other details of steps 601b to 603b may be referred to the description of the above embodiments, which are not repeated herein in the embodiment of the present disclosure.

In step 604b, model information of an updated encoder model sent by the network device is received.

In an embodiment of the present disclosure, the model information of the updated encoder model may include:

all model information of the updated encoder model; or

model difference information between the model information of the updated encoder model and model information of the original encoder model.

In step 605b, the model is updated based on the model information of the updated encoder model.

In an embodiment of the present disclosure, the details of “updating the model based on the model information of the updated encoder model” will be described in subsequent embodiments.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 6c is a schematic flow diagram of a method of training and deploying a model according to an embodiment of the present disclosure, which is executed by a UE. As shown in FIG. 6c, the method may include the following steps.

In step 601c, capability information is reported to a network device.

In step 602c, model information of an encoder model sent by the network device is obtained.

In step 603c, the encoder model is generated based on the model information of the encoder model.

Other details of steps 601c to 603c may be referred to the description of the above embodiments, which are not repeated herein in the embodiment of the present disclosure.

In step 604c, model information of an updated encoder model sent by the network device is received.

In an embodiment of the present disclosure, the model information of the updated encoder model may include:
all model information of the updated encoder model; or
model difference information between the model information of the updated encoder model and model information of the original encoder model.

In step 605c, the updated encoder model is generated based on the model information of the updated encoder model.

In an embodiment of the present disclosure, when the model information of the updated encoder model received in the above step 604c is “all model information of the updated encoder model”, the UE may directly generate the updated encoder model based on all model information.

In another embodiment of the present disclosure, when the model information of the updated encoder model received in the above step 604c is the “model difference information between the model information of the updated encoder model and model information of the original encoder model”, the UE may first determine the model information of the original encoder model of the UE itself, then determine the model information of the updated encoder model based on the model information of the original encoder model and the model difference information, and then generate the updated encoder model based on the model information of the updated encoder model.

In step 606c, the model is updated by replacing an original encoder model with the updated encoder model.

In an embodiment of the present disclosure, after replacing the original encoder model with the updated encoder model, the UE may perform encoding using the updated encoder model. Based on the higher encoding accuracy of the updated encoder model, the subsequent processing accuracy of the signal may be ensured.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

FIG. 6d is a schematic flow diagram of a method of training and deploying a model according to an embodiment of the present disclosure, which is executed by a UE. As shown in FIG. 6d, the method may include the following steps.

In step 601d, capability information is reported to a network device.

In step 602d, model information of an encoder model sent by the network device is obtained.

In step 603d, the encoder model is generated based on the model information of the encoder model.

In step 604d, model information of an updated encoder model sent by the network device is received.

Other details of steps 601d to 604d may be referred to the description of the above embodiments, which are not repeated herein in the embodiment of the present disclosure.

In step 605dthe model is updated by optimizing an original decoder model based on the model information of the updated encoder model.

In an embodiment of the present disclosure, when the model information of the updated encoder model received in the above step 604d is “all model information of the updated encoder model”, the UE may first determine the model difference information between the all model information and the model information of the original encoder model, and then update the model by optimizing the original decoder model based on the model difference information.

In another embodiment of the present disclosure, when the model information of the updated encoder model received in the above step 604d is the “model difference information between the model information of the updated encoder model and model information of the original encoder model”, the UE may update the model by directly optimizing the original decoder model based on the model difference information.

Specifically, in an embodiment of the present disclosure, after the original encoder model is optimized and adjusted based on the model difference information, the model information of the optimized and adjusted encoder model may be consistent with the model information of the updated encoder model, so that the UE may subsequently perform a encoding operation using the updated encoder model. Based on the high encoding accuracy of the updated encoder model, the subsequent processing accuracy of the signal may be ensured.

In view of the above, in the method provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

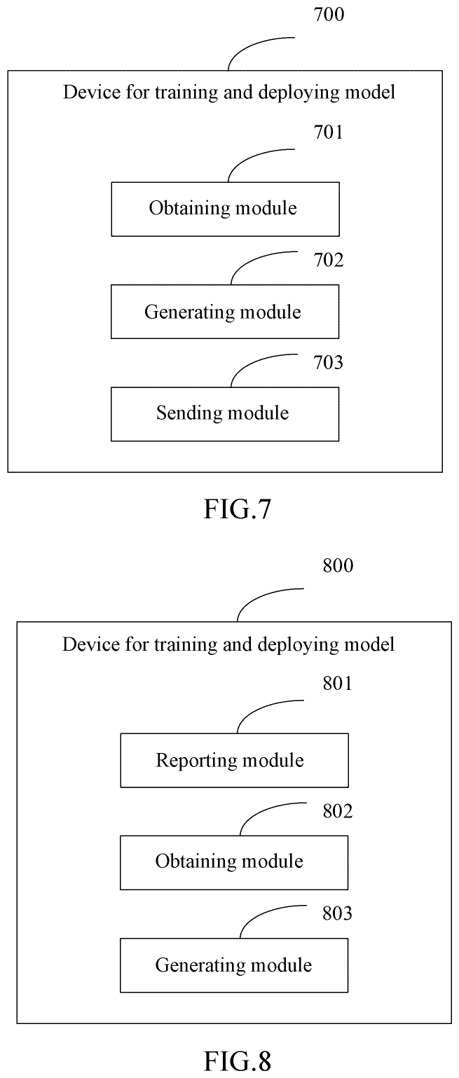

FIG. 7 is a schematic structure diagram of a device for training and deploying a model according to an embodiment of the present disclosure. As shown in FIG. 7, the device may include:
an obtaining module, configured to obtain capability information reported by a UE, the capability information being configured to indicate an AI supporting capability and/or an ML supporting capability of the UE;
a generating module, configured to generate an encoder model and a decoder model based on the capability information; and
a sending module, configured to send model information of the encoder model to the UE, the model information of the encoder model being configured to deploy the encoder model.

In view of the above, in the device provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

Optionally, in an embodiment of the present disclosure, the model may include at least one of:
an AI model; or
an ML model.

Optionally, in an embodiment of the present disclosure, the capability information may include at least one of:
whether the UE supports AI;
whether the UE supports ML;
a kind of an AI model and/or an ML model supported by the UE; or
maximum supporting capability information of the UE for the model, the maximum supporting capability information comprising structure information of a most-complex model supported by the UE.

Optionally, in an embodiment of the present disclosure, the generating module is further configured to:
select a to-be-trained encoder mode and/or a to-be-trained decoder model based on the capability information, the to-be-trained encoder model being a model supported by the UE, and the to-be-trained decoder model being a model supported by the network device;
determine sample data based on at least one of information reported by the UE or information stored by the network device; and
generate the encoder model and the decoder model by training the to-be-trained encoder model and/or the to-be-trained decoder model based on the sample data. Optionally, in an embodiment of the present disclosure, the model information of the encoder model includes at least one of:
a kind of the encoder model; or
a model parameter of the encoder model.

Optionally, in an embodiment of the present disclosure, the device is further configured to:

send indication information to the UE, the indication information being configured to indicate an information type used when the UE reports to the network device, the information type includes at least one of:

raw reporting information not encoded by the encoder model; or

information obtained by the encoder model encoding the raw reporting information.

Optionally, in an embodiment of the present disclosure, the reporting information is information to be reported by the UE to the network device, and the reporting information includes CSI information, the CSI information includes at least one of:
channel information;
characteristic matrix information of a channel;
eigenvector information of the channel;
PMI;
CQI;
RI;
RSRP;
RSRQ;
SINR; or
reference signal resource indication.

Optionally, in an embodiment of the present disclosure, the information type indicated by the indication information includes the information obtained by the encoder model encoding the raw reporting information, and
the device is further configured to:
decode, in response to receiving information reported by the UE, the information reported by the UE using the decoder model.

Optionally, in an embodiment of the present disclosure, the device is further configured to:
update the encoder model and the decoder model to generate an updated encoder model and an updated decoder model.

Optionally, in an embodiment of the present disclosure, the device is further configured to:
determine a new encoder model and a new decoder model based on an original encoder model and an original decoder model; and
obtain the updated encoder model and the updated decoder model by retraining the new encoder model and the new decoder model.

Optionally, in an embodiment of the present disclosure, the device is further configured to:
monitor a distortion degree of an original encoder model and an original decoder model;
when the distortion degree exceeds a first threshold, determine a new encoder model and a new decoder model based on the original encoder model and the original decoder model; and
obtain the updated encoder model and the updated decoder model by retraining the new encoder model and the new decoder model, wherein a distortion degree of the updated encoder model and the updated decoder model is less than a second threshold, and the second threshold is less than or equal to the first threshold.

Optionally, in an embodiment of the present disclosure, the device is further configured to:
obtain the new encoder model and the new decoder model by adjusting a model parameter of the original encoder model and the original decoder model; or
re-select the new encoder model and the new decoder model based on the capability information, a kind of the new encoder model and the new decoder model being different from a kind of the original encoder model and the original decoder model. Optionally, in an embodiment of the present disclosure, the device is further configured to:
directly replace an original decoder model with the updated decoder model.

Optionally, in an embodiment of the present disclosure, the device is further configured to:
determine model difference information between model information of the updated decoder model and model information of an original decoder model; and
optimize the original decoder model based on the model difference information.

Optionally, in an embodiment of the present disclosure, the device is further configured to:
send model information of the updated encoder model to the UE.

Optionally, in an embodiment of the present disclosure, the model information of the updated encoder model includes:
all model information of the updated encoder model; or
model difference information between the model information of the updated encoder model and model information of the original encoder model.

FIG. 8 is a schematic structure diagram of a device for training and deploying a model according to an embodiment of the present disclosure. As shown in FIG. 8, the device may include:
a reporting module, configured to report capability information to a network device, the capability information being configured to indicate an AI supporting capability and/or an ML supporting capability of the UE;
an obtaining module, configured to obtain model information of an encoder model sent by the network device, the model information of the encoder model being configured to deploy the encoder model; and
a generating module, configured to generate the encoder model based on the model information of the encoder model.

In view of the above, in the device provided by the embodiment of the present disclosure, the network device may first obtain the capability information reported by the UE, which is configured to indicate the AI and/or ML supporting capability of the UE, and then the network device may generate the encoder model and the decoder model based on the capability information, and send the model information of the encoder model to the UE. The model information of the encoder model is configured to deploy the encoder model, so the UE may generate the encoder model based on the model information of the encoder model. Therefore, the embodiments of the present disclosure provide a method for generating and deploying a model that can be used to train and deploy an AI/ML model.

Optionally, in an embodiment of the present disclosure, the model includes at least one of:
an AI model; or
an ML model.

Optionally, in an embodiment of the present disclosure, the capability information includes at least one of:
whether the UE supports AI;
whether the UE supports ML;
a kind of an AI model and/or an ML model supported by the UE; or
maximum supporting capability information of the UE for the model, the maximum supporting capability information comprising structure information of a most-complex model supported by the UE.

Optionally, in an embodiment of the present disclosure, the model information of the encoder model includes at least one of:
a kind of the encoder model; or a model parameter of the encoder model.

Optionally, in an embodiment of the present disclosure, the device is further configured to:
obtain indication information sent by the network device, the indication information being configured to indicate an information type used when the UE reports to the network device, the information type including at least one of raw reporting information not encoded by the encoder model, or information obtained by the encoder model encoding the raw reporting information; and report to the network device based on the indication information.

Optionally, in an embodiment of the present disclosure, the reporting information is information to be reported by the UE to the network device, and the reporting information includes CSI information,

the CSI information includes at least one of: channel information;
characteristic matrix information of a channel;
eigenvector information of the channel;
PMI;
CQI;
RI;
RSRP;
RSRQ;
SINR; or
reference signal resource indication.

Optionally, in an embodiment of the present disclosure, the information type indicated by the indication information includes the information obtained by the encoder model encoding the raw reporting information, and
the device is further configured to:
encode the reporting information using the encoder model; and
report encoded information to the network device.

Optionally, in an embodiment of the present disclosure, the device is further configured to:
receive model information of an updated encoder model sent by the network device; and
update the model based on the model information of the updated encoder model.

Optionally, in an embodiment of the present disclosure, the model information of the updated encoder model includes:
all model information of the updated encoder model; or
model difference information between the model information of the updated encoder model and model information of the original encoder model.

Optionally, in an embodiment of the present disclosure, the device is further configured to:
generate the updated encoder model based on the model information of the updated encoder model; and
update the model by replacing an original encoder model with the updated encoder model.

Optionally, in an embodiment of the present disclosure, the model information of the updated encoder model includes:
updating the model by optimizing an original decoder model based on the model information of the updated encoder model.

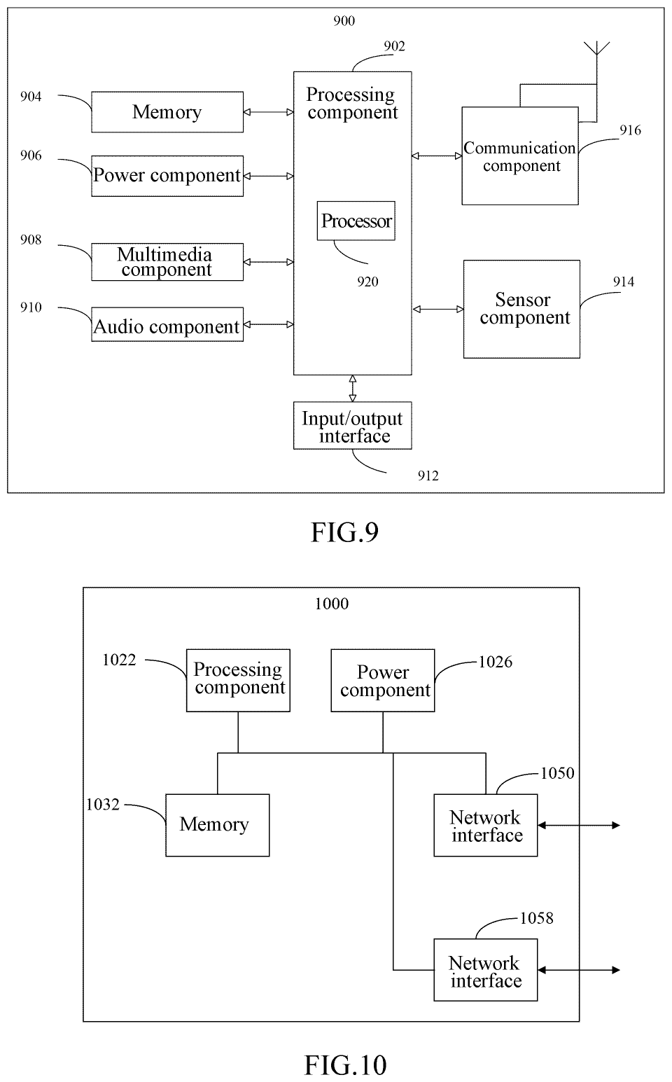

FIG. 9 is a block diagram of a user equipment UE 900 according to an embodiment of the present disclosure. For example, the UE 900 may be a mobile phone, a computer, a digital broadcast terminal device, a message transceiver device, a game console, a tablet device, a medical device, a fitness device, a personal digital assistant, and the like.

Referring to FIG. 9, the UE 900 may include at least one of a processing component 902, a memory 904, a power component 906, a multimedia component 908, an audio component 910, an input/output (I/O) interface 912, a sensor component 914, and a communication component 916.

The processing component 902 generally controls the overall operations of the UE 900, such as operations associated with display, telephone calls, data communications, camera operations, and recording operations. The processing component 902 may include at least one processor 920 to execute instructions to complete all or part of the steps of the foregoing method. In addition, the processing component 902 may include at least one module to facilitate interaction between the processing component 902 and other components. For example, the processing component 902 may include a multimedia module to facilitate the interaction between the multimedia component 908 and the processing component 902.

The memory 904 is configured to store various types of data to support the operation at the UE 900. Examples of these data include instructions for any application or method operating on the UE 900, contact data, phone book data, messages, pictures, videos and the like. The memory 904 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 906 provides power to various components of the UE 900. The power component 906 may include a power management system, at least one power supply, and other components associated with generating, managing, and distributing power for the UE 900.

The multimedia component 908 includes a screen that provides an output interface between the UE 900 and the user. In some embodiments, the screen may include a liquid crystal display (LCD) and a touch panel (TP). If the screen includes a touch panel, the screen may be implemented as a touch screen to receive input signals from the user. The touch panel includes at least one touch sensor to sense touch, sliding, and gestures on the touch panel. The touch sensor may not only sense the boundary of the touch or slide action, but also detect the duration and pressure related to the touch or slide operation. In some embodiments, the multimedia component 908 includes a front camera and/or a rear camera. When the UE 900 is in an operation mode, such as a shooting mode or a video mode, the front camera and/or the rear camera can receive external multimedia data. Each of the front camera and rear camera may be a fixed optical lens system or have focal length and optical zoom capabilities.

The audio component 910 is configured to output and/or be input audio signals. For example, the audio component 910 includes a microphone (MIC), and when the UE 900 is in an operation mode, such as a call mode, a recording mode, and a voice recognition mode, the microphone is configured to receive an external audio signal. The received audio signal can be further stored in the memory 904 or sent via the communication component 916. In some embodiments, the audio component 910 further includes a speaker for outputting audio signals.

The I/O interface 912 provides an interface between the processing component 902 and a peripheral interface module. The above-mentioned peripheral interface module may be a keyboard, a click wheel, a button, and the like. These buttons may include but are not limited to home button, volume button, start button, and lock button. The sensor component 914 includes at least one sensor for providing the UE 900 with various aspects of state evaluation. For example, the sensor component 914 can detect the on/off status of the UE 900 and the relative positioning of components. For example, the component is a display and keypad of the UE 900. The sensor component 914 can also detect the position change of the UE 900 or a component of the UE 900, the presence or absence of contact between the user and the UE 900, the orientation or acceleration/deceleration of the UE 900, and the temperature change of the UE 900. The sensor component 914 may include a proximity sensor configured to detect the presence of nearby objects when there is no physical contact. The sensor component 914 may also include a light sensor, such as a CMOS or CCD image sensor, for use in imaging applications. In some embodiments, the sensor component 914 may also include an acceleration sensor, a gyroscope sensor, a magnetic sensor, a pressure sensor, or a temperature sensor.

The communication component 916 is configured to facilitate wired or wireless communication between the UE 900 and other devices. The UE 900 can access a wireless network based on a communication standard, such as WiFi, 2G, 3G, 4G, 5G or a combination thereof. In an embodiment, the communication component 916 receives a broadcast signal or broadcast related information from an external broadcast management system via a broadcast channel. In an embodiment, the communication component 916 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the UE 900 may be implemented by at least one of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

FIG. 10 is a block diagram of a network side device 1000 according to an embodiment of the present disclosure. For example, the network side device 1000 may be provided as a network side device. Referring to FIG. 10, the network side device 1000 includes a processing component 1011, which further includes at least one processor, and a memory resource represented by a memory 1032 for storing instructions, such an application program, that may be executed by the processing component 1022. The application program stored in memory 1032 may include one or more modules each corresponding to a set of instructions. In addition, the processing component 1010 is configured to execute instructions to perform any of the methods described above and applied to the network side device, for example, the method shown in FIG. 1.

The network side device 1000 may also include a power component 1026 configured to perform power management of the network side device 1000, a wired or wireless network interface 1050 configured to connect the network side device 1000 to a network, and an input/output (I/O) interface 1058. The network side device 1000 may operate based on an operating system stored in the memory 1032, for example, Windows Server™, Mac OS X™, Unix™, Linux™, Free BSD™ or the like.

In the above embodiments of the present disclosure, the methods provided by the embodiments of the present disclosure are described from the perspectives of the network side device and the UE, respectively. In order to implement each of the functions in the method provided by the above embodiments of the present disclosure, the network side device and the UE may include a hardware structure and a software module to implement each of the above functions in the form of the hardware structure, the software module, or the hardware structure plus the software module. One of the above functions may be performed in the form of the hardware structure, the software module, or the hardware structure plus the software module.

An embodiment of the present disclosure provides a communication device. The communication device may include a transceiver module and a processing module. The transceiver module may include a sending module and/or a receiving module, the sending module is configured for implementing a sending function, and the receiving module is configured for implementing a receiving function, and the transceiver module may implement the sending function and/or the receiving function.

The communication device may be a terminal device (such as the terminal device in the above method embodiment), a device in a terminal device, or a device that can be used in conjunction with a terminal device. Alternatively, the communication device may be a network device, a device in a network device, or a device that can be used in conjunction with a network device.

An embodiment of the present disclosure provides another communication device. The communication device may be a network device or a terminal device (such as the terminal device in the above method embodiment), or may be a chip, a chip system, or a processor, etc. that supports the network device to implement the above method, or may be a chip, a chip system, or a processor, etc. that supports the terminal device to implement the above method. The device may be used to implement the method described in the above method embodiment, details of which may refer to the description of the above method embodiment.

The communication device may include one or more processors. The processor may be a general-purpose processor or a dedicated processor, etc. For example, it may be a baseband processor or a central processing unit. The baseband processor may be used for processing the communication protocol and the communication data, and the central processing unit may be used for controlling the communication device (e.g., a network side device, a baseband chip, a terminal device, a terminal device chip, DU or CU, etc.), executing a computer program, and processing the data of the computer program.

Optionally, the communication device may further include one or more memories on which a computer program may be stored, and the processor may execute the computer program to cause the communication device to perform the method described in the above method embodiment. Optionally, data may also be stored in the memory. The communication device and the memory may be provided separately or may be integrated together.

Optionally, the communication device may further include a transceiver and an antenna. The transceiver may be referred to as a transceiver unit, a transceiver machine, a transceiver circuit or the like, to implement a transceiver function. The transceiver may include a receiver and a sender, the receiver may be referred to as a receiving machine, a receiving circuit, or the like to implement a receiving function, and the sender may be referred to as a sending machine, a sending circuit or the like to implement a sending function.

Optionally, the communication device may further include one or more interface circuits. The interface circuit is used to receive code instructions and transmit the same to a processor. The processor runs the code instructions to cause the communication device to perform the method described in the above method embodiment.

The communication device is a terminal device (such as the terminal device in the above method embodiment), and the processor is used to perform the method shown in any of FIGS. 4 to 6d.

The communication device is a network device, and the transceiver is used to perform the method shown in any of FIGS. 1 to 3e.

In an implementation, the processor may include a transceiver for implementing receiving and sending functions. The transceiver may for example be a transceiver circuit, or an interface, or an interface circuit. The transceiver circuit, interface, or interface circuit for implementing the receiving and sending functions may be separate or may be integrated together. The transceiver circuit, interface, or interface circuit described above may be used for code/data reading and writing, or the transceiver circuit, interface, or interface circuit described above may be used for signal transmission or delivery.

In an implementation, the processor may store a computer program, and the computer program may run on the processor to cause the communication device to perform the method described in the above method embodiment. The computer program may be solidified in the processor, in which case the processor may be implemented by hardware.

In an implementation, the communication device may include a circuit, and the circuit may implement the sending or receiving or communicating function in the above method embodiment. The processor and transceiver described in the present disclosure may be implemented in an integrated circuit (IC), analog IC, radio frequency integrated circuit RFIC, mixed signal IC, application specific integrated circuit (ASIC), printed circuit board (PCB), electronic device or the like. The processor and transceiver may be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon-germanium (SiGe), gallium arsenide (GaAs) and so on.

The communication device described in the above embodiments may be a network device or a terminal device (such as the terminal device in the above method embodiments). However, the scope of the communication device described in the present disclosure is not limited thereto, and the structure of the communication device may be not limited. The communication device may be a stand-alone device or may be part of a large device. For example, the communication device may be:
(1) a stand-alone integrated circuit IC, or chip, or chip system or subsystem;
(2) a collection of one or more ICs, optionally, the IC collection may also include a storage component for storing data and computer program;
(3) an ASIC, such as a modem;
(4) a module that can be embedded in other devices;
(5) a receiver, terminal device, smart terminal device, cellular phone, wireless device, handheld device, mobile unit, in-vehicle device, network device, cloud device, artificial intelligence device, and the like;
(6) others.

For the case where the communication device may be a chip or a chip system, the chip includes a processor and an interface. The number of processors may be one or more and the number of interfaces may be more than one.

Optionally, the chip also includes a memory for storing necessary computer programs and data.

A person skilled in the art may also appreciate that the various illustrative logical blocks and steps listed in the embodiments of the present disclosure may be implemented by electronic hardware, computer software, or a combination thereof. Whether such function is implemented by hardware or software depends on the particular application and the design requirement of the entire system. A person skilled in the art may, for each particular application, may use various methods to implement the described function, but such implementation should not be construed as being outside the protection scope of the embodiments of the present disclosure.

An embodiment of the present disclosure also provides a system, and the system includes a communication device as a terminal device and a communication device as a network device in the above embodiment.

The present disclosure also provides a readable storage medium having stored thereon instructions which, when executed by a computer, implement the function in any of the above method embodiments.

The present disclosure also provides a computer program product which, when executed by a computer, implement the function in any of the above method embodiments.

In the above embodiments, it may be achieved in whole or in part by software, hardware, firmware, or any combination thereof. When being implemented using software, it may be implemented in whole or in part in the form of a computer program product. The computer program product includes one or more computer programs. When the computer programs are loaded and executed on a computer, all or part of the processes or functions according to the embodiments of the present disclosure may be generated. The computer may be a general-purpose computer, a special-purpose computer, a computer network, or other programmable device. The computer program may be stored in a computer-readable storage medium or transmitted from one computer-readable storage medium to another computer-readable storage medium, e.g., the computer program may be transmitted from one web site, computer, server, or data center to another web site, computer, server or data center via a wired manner (e.g., coaxial cable, optical fiber, digital subscriber line (DSL)) or wireless manner (e.g., infrared, wireless, microwave, etc.). The computer-readable storage medium may be any usable medium to which a computer can access, or a data storage device such as a server, data center containing one or more usable media integrated. The usable medium may be a magnetic medium (e.g., a floppy disk, hard disk, tape), an optical medium (e.g., a high-density digital video disc (DVD)), or a semiconductor medium (e.g., a solid state disk (SSD)), and the like.

A person skilled in the art may understand that the terms such as first, second or the like involved in the description of the present disclosure are only for distinguishing purpose for easy description, and are not intended to limit the scope of the embodiments of the present disclosure and denote an order.

The term “at least one” in the present disclosure may also be described as one or more, and the term “a plurality of . . . ” may be two, three, four, or more, which is not limited in the present disclosure. In the embodiments of the present disclosure, for a kind of technical features, the “first”, “second”, “third”, “A”, “B”, “C”, “D”, or the like may be used to differentiate the technical features in such kind of technical features, and there is no precedence or magnitude order among these technical features described by the “first”, “second”, “third”, “A”, “B”, “C”, “D”, or the like.

Other embodiments of the present invention may be easily conceived of by a person skilled in the art upon consideration of the specification and practice of the invention disclosed herein. The present disclosure is intended to cover any variations, uses, or adaptations of the present invention that follow the general principle of the present invention and include the common knowledge and the customary technical means in the art not disclosed in the present disclosure. The specification and embodiments are to be regarded as exemplary only, and the true scope and spirit of the present disclosure are indicated by the appending claims.

It is to be understood that the present disclosure is not limited to the precise structure which has been described above and illustrated in the accompanying drawings, and that various modifications and alterations may be made without departing from the scope thereof. The scope of the present disclosure is limited only by the appending claims.

1. A method for training and deploying a model, which is performed by a network device, comprising:
obtaining capability information reported by a user equipment (UE), the capability information being configured to indicate at least one of an artificial intelligence (AI) supporting capability or a machine learning (ML) supporting capability of the UE;
generating an encoder model and a decoder model based on the capability information; and
sending model information of the encoder model to the UE, the model information of the encoder model being configured to deploy the encoder model.

2. The method according to claim 1, wherein the model comprises at least one of following models:
an AI model; or
an ML model,
wherein the capability information comprises at least one of following information:
a first capability information indicating whether the UE supports AI;
a second capability information indicating whether the UE supports ML;
a third capability information indicating a kind of an AI model or an ML model supported by the UE; or
a fourth capability information indicating maximum supporting capability information of the UE for the model, wherein the maximum supporting capability information comprising structure information of a most-complex model supported by the UE.

3. (canceled)

4. The method according to claim 1, wherein generating the encoder model and the decoder model based on the capability information comprises:
selecting at least one of a to-be-trained encoder mode or a to-be-trained decoder model based on the capability information, the to-be-trained encoder model being a model supported by the UE, and the to-be-trained decoder model being a model supported by the network device;
determining sample data based on at least one of information reported by the UE or information stored by the network device; and
generating the encoder model and the decoder model by training the to-be-trained encoder model or the to-be-trained decoder model based on the sample data.

5. The method according to claim 1, wherein the model information of the encoder model comprises at least one of following information:
a first model information indicating a kind of the encoder model; or
a second model information indicating a model parameter of the encoder model.

6. The method according to claim 1, further comprising:
sending indication information to the UE, the indication information being configured to indicate an information type used when the UE reports to the network device, wherein
the information type comprises at least one of:
raw reporting information not encoded by the encoder model; or
information obtained by the encoder model encoding the raw reporting information, wherein when the information type indicated by the indication information comprises the information obtained by the encoder model encoding the raw reporting information, wherein the method further comprises:
decoding, in response to receiving information reported by the UE, the information reported by the UE using the decoder model.

7. The method according to claim 6, wherein the reporting information is reported by the UE to the network device, and the reporting information comprises channel state information (CSI) information, wherein
the CSI information comprises at least one of following information:
channel information;
characteristic matrix information of a channel;
eigenvector information of the channel;
precoding matrix indicator (PMI);
channel quality indicator (CQI);
channel rank indicator (RI);
reference signal received power (RSRP);
reference signal received quality (RSRQ);
signal-to-interference plus noise ratio (SINR); or reference signal resource indication.

8. (canceled)

9. The method according to claim 1, further comprising:
updating the encoder model and the decoder model to generate an updated encoder model and an updated decoder model.

10. The method according to claim 9, wherein updating the encoder model and the decoder model comprises:
determining a new encoder model and a new decoder model based on an original encoder model and an original decoder model; and
obtaining the updated encoder model and the updated decoder model by retraining the new encoder model and the new decoder model.

11. The method according to claim 9, wherein updating the encoder model and the decoder model comprises:
monitoring a distortion degree of an original encoder model and an original decoder model;
determining, in response to that the distortion degree exceeds a first threshold, a new encoder model and a new decoder model based on the original encoder model and the original decoder model; and
obtaining the updated encoder model and the updated decoder model by retraining the new encoder model and the new decoder model, wherein a distortion degree of the updated encoder model and the updated decoder model is less than a second threshold, and the second threshold is less than or equal to the first threshold.

12. The method according to claim 10, wherein determining the new encoder model and the new decoder model based on the original encoder model and the original decoder model comprises:
obtaining the new encoder model and the new decoder model by adjusting a model parameter of the original encoder model and the original decoder model; or
re-selecting the new encoder model and the new decoder model based on the capability information, a kind of the new encoder model and the new decoder model being different from a kind of the original encoder model and the original decoder model.

13. The method according to claim 9, further comprising:
directly replacing an original decoder model with the updated decoder model; or
determining model difference information between model information of the updated decoder model and model information of an original decoder model, and optimizing the original decoder model based on the model difference information.

14. (canceled)

15. The method according to claim 9, further comprising:
sending model information of the updated encoder model to the UE,
wherein the model information of the updated encoder model comprises:
all model information of the updated encoder model; or
model difference information between the model information of the updated encoder model and model information of the original encoder model.

16. (canceled)

17. A method for training and deploying a model, which is performed by a UE, comprising:
reporting capability information to a network device, the capability information being configured to indicate at least one of an AI supporting capability or an ML supporting capability of the UE;
obtaining model information of an encoder model sent by the network device, the model information of the encoder model being configured to deploy the encoder model; and
generating the encoder model based on the model information of the encoder model.

18. The method according to claim 17, wherein the model comprises at least one of following models:
an AI model; or
an ML model,
wherein the capability information comprises at least one of following information:
a first capability information indicating whether the UE supports AI;
a second capability information indicating whether the UE supports ML;
a third capability information indicating a kind of an AI model or an ML model supported by the UE; or
a fourth capability information indicating maximum supporting capability information of the UE for the model, the maximum supporting capability information comprising structure information of a most-complex model supported by the UE.

19. (canceled)

20. The method according to claim 17, wherein the model information of the encoder model comprises at least one of following information:
a first model information indicating a kind of the encoder model; or
a second model information indicating a model parameter of the encoder model.

21. The method according to claim 17, further comprising:
obtaining indication information sent by the network device, the indication information being configured to indicate an information type used when the UE reports to the network device, the information type comprising at least one of raw reporting information not encoded by the encoder model, or information obtained by the encoder model encoding the raw reporting information; and
reporting to the network device based on the indication information,
wherein when the information type indicated by the indication information comprises the information obtained by the encoder model encoding the raw reporting information, wherein reporting to the network device based on the indication information comprises:
encoding the reporting information using the encoder model; and
reporting encoded information to the network device.

22. The method according to claim 21, wherein the reporting information is reported by the UE to the network device, and the reporting information comprises CSI information, wherein the CSI information comprises at least one of following information:
channel information;
characteristic matrix information of a channel;
eigenvector information of the channel;
PMI;
CQI;
RI;
RSRP;
RSRQ;
SINR; or
reference signal resource indication.

23. (canceled)

24. The method according to claim 17, further comprising:
receiving model information of an updated encoder model sent by the network device; and
updating the model based on the model information of the updated encoder model,
wherein the model information of the updated encoder model comprises:
all model information of the updated encoder model; or
model difference information between the model information of the updated encoder model and model information of the original encoder model.

25. (canceled)

26. The method according to claim 24, wherein updating the model based on the model information of the updated encoder model comprises:
generating the updated encoder model based on the model information of the updated encoder model, and updating the model by replacing an original encoder model with the updated encoder model; or
updating the model by optimizing an original decoder model based on the model information of the updated encoder model.

27-29. (canceled)

30. A communication device comprising a processor and a memory, wherein the memory has a computer program stored therein, and the processor executes the computer program stored in the memory to cause the communication device to implement actions comprising:
obtaining capability information reported by a user equipment (UE), the capability information being configured to indicate at least one of an artificial intelligence (AI) supporting capability or a machine learning (ML) supporting capability of the UE;
generating an encoder model and a decoder model based on the capability information; and
sending model information of the encoder model to the UE, the model information of the encoder model being configured to deploy the encoder model.

31-35. (canceled)
